(19) United States
(12) Patent Application Publication
(10) Pub. No.: US 2026/0005238 A1
(43) Pub. Date: Jan. 1, 2026

(54) CATHODE ACTIVE MATERIAL FOR LITHIUM SECONDARY BATTERY AND LITHIUM SECONDARY BATTERY INCLUDING THE SAME

(71) Applicant: SK ON CO., LTD., Seoul (KR)

(72) Inventors: Byoung Beom LIM, Daejeon (KR); Min Suk KANG, Daejeon (KR); Ji Yae DO, Daejeon (KR); Sang Wook LEE, Daejeon (KR); Sang Han LEE, Daejeon (KR); Yong Hyun CHO, Daejeon (KR)

(21) Appl. No.: 19/249,982

(22) Filed: Jun. 25, 2025

(30) Foreign Application Priority Data
Jun. 26, 2024 (KR) 10-2024-0083699

(51) Int. Cl. H01M 4/525; C01G 53/42; H01M 10/052

(52) U.S. Cl. CPC H01M 4/525; C01G 53/42; H01M 10/052; C01P 2002/52; C01P 2002/54; C01P 2002/70; C01P 2004/50; C01P 2006/40

(57) ABSTRACT

Embodiments of the present disclosure relate to a cathode active material for lithium secondary battery including lithium-transition metal composite oxide particles. In the lithium-transition metal composite oxide particles, a (105) plane FWHM ratio measured through in-situ X-ray diffraction (XRD) and defined by Equation 1 is less than or equal to 600%. The life characteristics of a lithium secondary battery can be improved by preventing deformation of a lattice structure and/or crystal structure within the lithium-transition metal composite oxide particles.

### CROSS-REFERENCE TO RELATED APPLICATION AND CLAIM OF PRIORITY

This application claims priority to Korean Patent Application No. 10-2024-0083699, filed on Jun. 26, 2024, in the Korean Intellectual Property Office (KIPO), the entire disclosure of which is incorporated by reference herein.

### TECHNICAL FIELD

The present disclosure relates to a cathode active material for lithium secondary battery and a lithium secondary battery including the same. More specifically, the present disclosure relates to a cathode active material for lithium metal oxide-based lithium secondary battery and a lithium secondary battery including the same.

### BACKGROUND

Secondary batteries are batteries that can be repeatedly charged and discharged. With the development of information and communication and display industries, the secondary batteries are widely applied as a power source for portable electronic communication devices, such as camcorders, mobile phones, and laptop PCs. In addition, battery packs including the secondary batteries have been recently developed and applied as a power source for eco-friendly vehicles, such as hybrid cars.

Examples of the secondary battery include a lithium secondary battery, a nickel-cadmium battery, and a nickel-hydrogen battery. Among these, because the lithium secondary battery has a high operating voltage and a high energy density per unit weight and is advantageous in terms of charging speed and weight reduction, the lithium secondary battery is actively being researched and developed.

The lithium secondary battery may include an electrode assembly including a cathode, an anode, and a separator, and an electrolyte in which the electrode assembly is impregnated. The lithium secondary battery may further include, for example, a pouch-shaped outer case that accommodates the electrode assembly and the electrolyte.

A lithium-transition metal composite oxide may be used as an active material for the cathode of the lithium secondary battery. Examples of the lithium-transition metal composite oxide may include a nickel-based lithium metal oxide.

As the application range of the lithium secondary batteries expands, longer life, higher capacity, and operational stability are required for the lithium secondary batteries. For the lithium-transition metal composite oxide used as the active material for the cathode, if non-uniformity of a chemical structure increases due to distortion of a crystal structure, it may be difficult to implement a lithium secondary battery with the desired capacity and life. Further, if deformation or damage occurs in the structure of the lithium-transition metal composite oxide during repeated charging and discharging, the life stability and capacity retention characteristics may deteriorate.

### SUMMARY

In an aspect of the present disclosure, there is provided a cathode active material for lithium secondary battery with improved life characteristics and a lithium secondary battery including the same.

According to embodiments, there is provided a cathode active material for lithium secondary battery including lithium-transition metal composite oxide particles in which a (105) plane FWHM ratio measured through in-situ X-ray diffraction (XRD) and defined by Equation 1 below is less than or equal to 600%.

$$( 105 ) plane FWHM ratio ( \% ) = 100 * ( {FWHM}_{max} ( 105 ) / {FWHM}_{min} ( 105 ) ) \qquad [ Equation 1 ]$$

In Equation 1, FWHMₘₐₓ(105) is a maximum FWHM value of a (105) plane peak of the lithium-transition metal composite oxide particles measured through the in-situ XRD, and FWHMₘᵢₙ(105) is a minimum FWHM value of the (105) plane peak of the lithium-transition metal composite oxide particles measured through the in-situ XRD.

According to embodiments, the (105) plane FWHM ratio may be 450 to 550%.

According to embodiments, the (105) plane FWHM ratio may be 512 to 552%.

According to embodiments, the FWHMₘₐₓ(105) may be 0.5 to 1.0.

According to embodiments, the FWHMₘᵢₙ(105) may be 0.1 to 0.16.

According to embodiments, a change in a FWHM value of the (105) plane peak of the lithium-transition metal composite oxide particles based on a charge and a discharge of the lithium secondary battery may be measured in real time through the in-situ XRD.

According to embodiments, the lithium-transition metal composite oxide particles may include at least one doping element.

According to embodiments, the lithium-transition metal composite oxide particles may have a secondary particle structure including a plurality of primary particles.

According to embodiments, the secondary particle structure may include 2 to 5 primary particles.

According to embodiments, the lithium-transition metal composite oxide particles may have a single crystal structure.

According to embodiments, the lithium-transition metal composite oxide particles may be represented by formula 1 below.

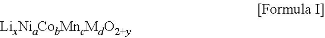

In formula 1, M may include at least one of Ti, Zr, Al, Mg or W, and 0.8<x<1.5, 0.70≤a≤0.98, 0≤b≤0.20, 0.02≤c≤0.30, 0≤d≤0.05, 0.98≤a+b+c≤1.02, and −0.1≤y≤0.1.

According to embodiments, in the Formula 1, 0.85≤a≤0.98.

According to embodiments, there is provided a lithium secondary battery including a cathode including a cathode active material layer including the cathode active material for lithium secondary battery described above; and an anode opposite the cathode.

The (105) plane FWHM ratio measured through the in-situ XRD of the lithium-transition metal composite oxide particles included in the cathode active material according to embodiments of the present disclosure may be less than or equal to 600%. Within a range of the FWHM ratio, the distortion of a lattice structure and/or crystal structure of the lithium-transition metal composite oxide particles can be suppressed. In addition, particle cracks and side reactions within electrodes can be suppressed. Accordingly, a gas generation amount of the lithium secondary battery can be reduced and the life characteristics can be improved.

In some embodiments, the lithium-transition metal composite oxide particles may have a single crystal structure. In this case, the durability of the electrodes is improved, and the lithium secondary battery with improved long-term life characteristics can be implemented.

In some embodiments, the lithium-transition metal composite oxide particles may include at least one doping element. In this case, the doping element may be uniformly distributed in a lithium site or a transition metal site of the lithium-transition metal composite oxide particles, so that the structural stability of the lithium-transition metal composite oxide particles can be improved upon intercalation/deintercalation of lithium ions. Accordingly, the distortion of the lattice structure and/or the crystal structure and a phase transition of the lithium-transition metal composite oxide particles can be suppressed.

The lithium secondary battery according to embodiments of the present disclosure can be implemented as a high-capacity battery by including the cathode active material while also improving long-term life characteristics and high temperature performance.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIGS. 1 and 2 are a plan view and a cross-sectional view schematically illustrating a lithium secondary battery according to embodiments, respectively.

### DETAILED DESCRIPTION OF THE EMBODIMENTS

Embodiments of the present disclosure provide a cathode active material including lithium-transition metal composite oxide particles and a lithium secondary battery including the cathode active material.

Reference will now be made in detail to embodiments of the disclosure, examples of which are illustrated in the accompanying drawings. However, the following description is merely an example and does not intend to limit embodiments of the disclosure to a specific implementation.

In embodiments of the present disclosure, the cathode active material may include lithium-transition metal composite oxide particles. For example, an amount of the lithium-transition metal composite oxide particles based on the total weight of the cathode active material may be 50 wt % or more. In some embodiments, the amount of the lithium-transition metal composite oxide particles based on the total weight of the cathode active material may be 60 wt % or more, 70 wt % or more, 80 wt % or more, or 90 wt % or more. In an embodiment, the cathode active material may substantially include the lithium-transition metal composite oxide particles.

According to embodiments, the lithium-transition metal composite oxide particles may have a secondary particle structure including a plurality of primary particles. For example, the lithium-transition metal composite oxide particles may have a secondary particle structure including 2 to 5 primary particles.

In some embodiments, the plurality of primary particles may aggregate to form secondary particles.

According to embodiments, the lithium-transition metal composite oxide particles may have a single crystal structure. In some embodiments, the lithium-transition metal composite oxide particles may have a secondary particle structure including a plurality of single crystal primary particles.

In some embodiments, the lithium-transition metal composite oxide particles may include nickel (Ni) and may further include at least one of cobalt (Co) or manganese (Mn).

Ni may be provided as a transition metal associated with an output and a capacity of the lithium secondary battery. Therefore, a high-power cathode and a high-power lithium secondary battery may be provided by adopting a high-Ni composition to the lithium-transition metal composite oxide particles.

However, as an amount of Ni increases, the long-term storage stability and life stability of the cathode or the secondary battery at a high temperature may be relatively reduced. However, according to embodiments, the life stability and capacity retention characteristics may be improved through Mn while maintaining electrical conductivity by including Co.

For example, the lithium-transition metal composite oxide particles may include a plurality of primary particles.

For example, based on the charge/discharge of the lithium secondary battery, distortion of a lattice structure within the primary particles included in the lithium-transition metal composite oxide particles or distortion between the primary particles may occur. In this case, a stress and a strain within the lithium-transition metal composite oxide particles may increase. Hence, cracks in the lithium-transition metal composite oxide particles may occur, and a gas generation amount of the lithium secondary battery may increase and the life characteristics may deteriorate.

For example, the distortion of the lattice structure and/or crystal structure described above may cause a peak shift when measured through X-ray diffraction (XRD). In this case, a width of each peak may increase or decrease as the charge/discharge progresses, and a Full Width at Half Maximum (FWHM) value may change. Hence, a difference between a maximum value of the FWHM and a minimum value of the FWHM during the charge and the discharge may increase.

In embodiments of the present disclosure, the lithium-transition metal composite oxide particles may have a (105) plane FWHM ratio of 600% or less as measured through in-situ XRD and defined by Equation 1 below.

$$( 105 ) plane FWHM ratio ( \% ) = 100 * ( {FWHM}_{max} ( 105 ) / {FWHM}_{min} ( 105 ) ) \qquad [ Equation 1 ]$$

In the Equation 1, FWHMₘₐₓ(105) may be a maximum FWHM value of a (105) plane peak of the lithium-transition metal composite oxide particle measured through the in-situ XRD. For example, the FWHMₘₐₓ(105) may be the maximum FWHM value of the (105) plane peak of the lithium-transition metal composite oxide particle measured through the in-situ XRD while charging and discharging the lithium secondary battery once.

In the Equation 1, FWHMₘᵢₙ(105) may be a minimum FWHM value of the (105) plane peak of the lithium-transition metal composite oxide particle measured through the in-situ XRD. For example, the FWHMₘᵢₙ(105) may be the minimum FWHM value of the (105) plane peak of the lithium-transition metal composite oxide particle measured through the in-situ XRD while charging and discharging the lithium secondary battery once.

For example, the FWHMₘₐₓ(105) may be a FWHM value of the (105) plane peak at a point where the crystal structure of the lithium-transition metal composite oxide particles undergoes the greatest deformation during charge and discharge. In addition, the FWHMₘᵢₙ(105) may be a minimum value among FWHM values of the (105) plane peak before the crystal structure of the lithium-transition metal composite oxide particles undergoes deformation.

In embodiments, the in-situ XRD may be an equipment capable of observing changes in the crystal structure, etc. in real time during charge and discharge of the lithium secondary battery.

For example, the lithium secondary battery (e.g., a coin cell) may be attached to one side of the in-situ XRD and assembled. After formation charge and discharge (CC-CV 0.1C 4.2V 0.05C CUT-OFF, CC 0.1C CUT-OFF 2.5V) are performed on the assembled lithium secondary battery, charge and discharge may be performed again to perform an XRD analysis in real time. The charge and discharge may be performed under the same conditions as the formation charge and discharge, and an analysis may be performed once every about 7 to 8 minutes.

According to one embodiment, X′Pert PRO (made by PANalytical) may be used as the in-situ XRD analysis equipment.

For example, the changes in the FWHM value of the (105) plane peak of the lithium-transition metal composite oxide particles based on the charge and discharge of the lithium secondary battery may be measured in real time through the above-mentioned in-situ XRD. Hence, the degree of distortion of the lattice structure and/or the crystal structure of the lithium-transition metal composite oxide particles during the charge and discharge process may be evaluated in real time.

The distortion of the lattice structure and/or the crystal structure of the lithium-transition metal composite oxide particles can be suppressed within a range of the FWHM ratio. In addition, particle cracks and side reactions within electrodes can be suppressed. Accordingly, the gas generation amount of the lithium secondary battery can be reduced and the life characteristics can be improved.

When the (105) plane FWHM ratio exceeds 600%, the cathode active material may undergo a rapid change in the crystal structure during battery driving. Hence, the deterioration of the electrode life due to battery charging and discharging may be accelerated, and side reactions with the electrolyte may also occur, which may significantly reduce the life of the lithium secondary battery.

According to embodiments, the (105) plane FWHM ratio may be 450 to 600%. Or, according to embodiments, the (105) plane FWHM ratio may be 450 to 550%. According to embodiments, the (105) plane FWHM ratio may be 500 to 600%, or 500 to 550%, or 550 to 600%. According to embodiments, the (105) plane FWHM ratio may be 512 to 552%.

Deformation of the crystal structure and/or the lattice structure can be prevented while appropriately controlling the crystal grain size and crystallinity of the lithium-transition metal composite oxide particles within the range of the FWHM ratio. Hence, the life characteristics of the lithium secondary battery can be improved.

According to embodiments, the FWHMₘₐₓ(105) value may be 0.5 to 1.0. In some embodiments, the FWHMₘₐₓ(105) value may be 0.6 to 0.9. In some embodiments, the FWHMₘₐₓ(105) value may be 0.8325 or more, 0.9125 or more, or 0.9525 or more, and 0.9525 or less, 0.9125 or less, or 0.8325 or less. In this case, the lattice structure and/or the crystal structure of the lithium-transition metal composite oxide particles can be prevented from being excessively deformed during the charge/discharge process. Accordingly, the life characteristics and operating stability of the lithium secondary battery can be improved.

According to embodiments, the FWHMₘᵢₙ(105) value may be 0.1 to 0.16. In some embodiments, the FWHMₘᵢₙ(105) value may be 0.13 to 0.16. In some embodiments, the FWHMₘᵢₙ(105) value may be 0.1550 or more, 0.1653 or more, or 0.1860 or more, and 0.1860 or less, 0.1653 or less, or 0.1550 or less. In this case, deformation of the crystal structure and/or the lattice structure can be prevented while appropriately controlling the crystal grain size and crystallinity of the lithium-transition metal composite oxide particles. Accordingly, the life characteristics of the lithium secondary battery can be improved.

According to embodiments, the lithium-transition metal composite oxide particles may include at least one doping element. In this case, the doping elements may be uniformly distributed in a lithium (Li) site or a transition metal site of the lithium-transition metal composite oxide particles, so that the structural stability of the lithium-transition metal composite oxide particles can be improved upon intercalation/deintercalation of lithium ions. Hence, the distortion of the lattice structure and/or the crystal structure and a phase transition of the lithium-transition metal composite oxide particles can be suppressed, and thus, the (105) plane FWHM ratio can be reduced.

According to embodiments, the lithium-transition metal composite oxide particles may be represented by formula 1 below.

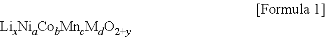

In the formula 1, M may include at least one of Ti, Zr, Al, Mg or W, 0.8<x<1.5, 0.70≤a≤0.98, 0≤b≤0.20, 0.02≤c≤0.30, 0≤d≤0.05, 0.98≤a+b+c≤1.02, and −0.1≤y≤0.1.

For example, M may be provided as a doping element.

The lithium-transition metal composite oxide particles represented by the Formula 1 may have improved structural stability while preventing an excessive reduction in capacity of the cathode active material through a small amount of metal doping when d is a value greater than 0. Accordingly, the life characteristics of the lithium secondary battery can be improved.

According to embodiments, in the formula 1, 0.85≤a≤0.98. When ‘a’ satisfies a value within the range, a higher capacity lithium secondary battery can be implemented because the amount of Ni in the cathode active material is high.

According to embodiments, the lithium-transition metal composite oxide particles may be formed through a reaction of a lithium precursor and a transition metal precursor (e.g., Ni—Co—Mn precursor).

For example, the transition metal precursor may be prepared through a coprecipitation reaction of metal salts. The metal salts may include a nickel salt, a manganese salt, and a cobalt salt.

Examples of the nickel salt may include nickel sulfate, nickel nitrate, nickel acetate, and hydrates thereof. Examples of the manganese salt may include manganese sulfate, manganese acetate, and hydrates thereof. Examples of the cobalt salt may include cobalt sulfate, cobalt nitrate, cobalt carbonate, and hydrates thereof.

The metal salts may be mixed with a precipitant and/or a chelating agent in a ratio satisfying an amount or a concentration ratio of each metal described with reference to the Formula 1 to prepare an aqueous solution. The aqueous solution may be coprecipitated in a reactor to prepare a transition metal precursor.

The precipitant may include an alkaline compound, such as sodium hydroxide (NaOH) and sodium carbonate (Na₂CO₃). Examples of the chelating agent may include ammonia water (e.g., NH₃H₂O), ammonium carbonate (e.g., NH₃HCO₃), etc.

A temperature of the coprecipitation reaction may be controlled, for example, in a range of about 40° C. to 60° C. A reaction time may be controlled in a range of about 24 to 72 hours.

For example, the lithium-transition metal composite oxide particles may be prepared by reacting the transition metal precursor with a doping element source including the lithium precursor and the doping element. For example, the lithium precursor compound may include lithium carbonate, lithium nitrate, lithium acetate, lithium oxide, lithium hydroxide, or the like. These may be used alone or in combination of two or more.

For example, the doping element source may include titanium dioxide, titanium butoxide, manganese sulfate hydrate, aluminum hydroxide, magnesium hydroxide, zirconium hydroxide, zirconium dioxide, yttria-stabilized zirconia, tungsten oxide, or the like. These may be used alone or in combination of two or more.

Afterwards, a heat treatment (predetermined) process may be performed to fix metal particles or increase the crystallinity. In an embodiment, a heat treatment temperature may be in a range of about 600° C. to 1,000° C.

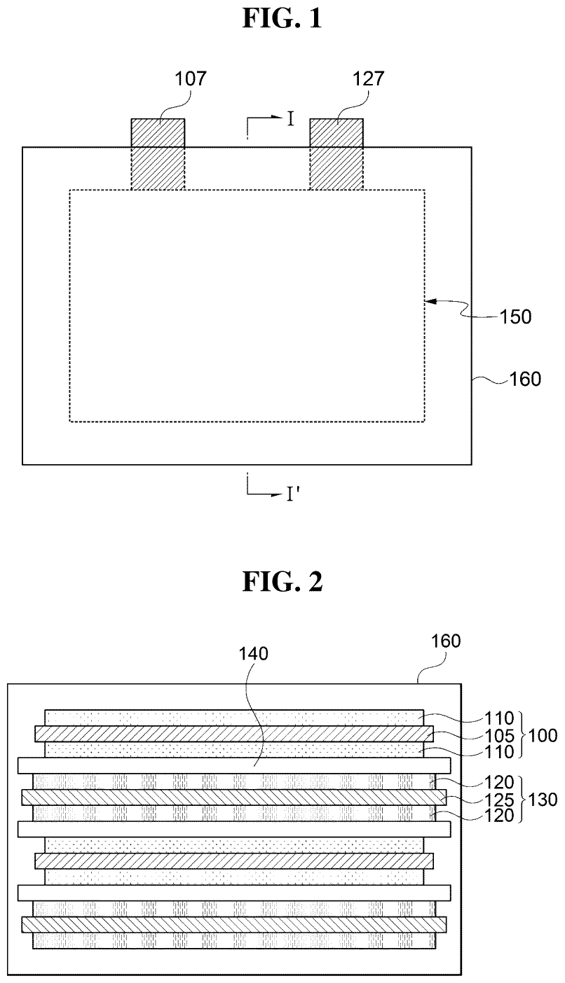

Hereinafter, a lithium secondary battery including a cathode including the cathode active material for lithium secondary battery described above is provided with reference to FIGS. 1 and 2.

Referring to FIGS. 1 and 2, a lithium secondary battery may include a cathode 100 including the above-described cathode active material and an anode 130 opposite the cathode 100.

The cathode 100 may include a cathode active material layer 110 formed by applying the cathode active material including the above-described lithium-transition metal composite oxide particles to a cathode current collector 105.

For example, the cathode active material manufactured by the above-described manufacturing method may be mixed and stirred with a binder, a conductive additive, and/or a dispersant in a solvent to manufacture a slurry. The slurry may be coated on at least one surface of the cathode current collector 105, and then dried and pressed to manufacture the cathode 100.

For example, the cathode current collector 105 may include stainless steel, nickel, aluminum, titanium, copper, or an alloy thereof, and may preferably include aluminum or an aluminum alloy.

For example, the binder may include an organic binder, such as polyvinylidene fluoride-co-hexafluoropropylene (PVDF-co-HFP), polyvinylidene fluoride (PVDF), polyacrylonitrile, and polymethylmethacrylate, or an aqueous binder, such as styrene-butadiene rubber (SBR). The binder may be used with a thickener, such as carboxymethyl cellulose (CMC).

For example, a PVDF series binder may be used as the binder for forming the cathode. In this case, an amount of the binder for forming the cathode active material layer 110 may be reduced, and an amount of the cathode active material may be relatively increased, thereby improving the output and capacity of the secondary battery.

The conductive additive may be included to promote electron transfer between active material particles. For example, the conductive additive may include a carbon series conductive additive, such as graphite, carbon black, graphene, and carbon nanotubes, and/or a metal series conductive additive including a perovskite material, such as tin, tin oxide, titanium oxide, LaSrCoO₃, and LaSrMnO₃.

The anode 130 may include an anode current collector 125 and an anode active material layer 120 formed by coating an anode active material on at least one surface of the anode current collector 125.

The anode active material may be any one known in the art that can intercalate and deintercalate lithium ions without particular limitation. For example, the anode active material may use a carbon-based material such as crystalline carbon, amorphous carbon, carbon composite, and carbon fiber; lithium alloy; silicon or tin, or the like. Examples of the amorphous carbon may include hard carbon, coke, mesocarbon microbead (MCMB) fired at 1500° C. or lower, and mesophase pitch-based carbon fiber (MPCF). Examples of the crystalline carbon may include graphite-based carbon such as natural graphite, graphitized coke, graphitized MCMB, and graphitized MPCF. Elements included in the lithium alloy may include aluminum, zinc, bismuth, cadmium, antimony, silicon, lead, tin, gallium, or indium.

For example, the anode current collector 125 may include gold, stainless steel, nickel, aluminum, titanium, copper, or an alloy thereof, and may preferably include copper or a copper alloy.

In some embodiments, the anode active material may be mixed and stirred with a binder, a conductive additive, and/or a dispersant in a solvent to manufacture a slurry. The slurry may be coated on the anode current collector 125, and then dried and pressed to manufacture the anode 130.

The binder and the conductive additive of the anode 130 may use materials substantially the same as or similar to the materials described above. In some embodiments, the binder for forming the anode may include, for example, an aqueous binder, such as styrene-butadiene rubber (SBR), for compatibility with a carbon-based active material, and may be used together with a thickener, such as carboxymethyl cellulose (CMC).

In some embodiments, a separator 140 may be interposed between the cathode 100 and the anode 130. The separator 140 may include a porous polymer film manufactured from a polyolefin polymer, such as an ethylene homopolymer, a propylene homopolymer, an ethylene/butene copolymer, an ethylene/hexene copolymer, and an ethylene/methacrylate copolymer. The separator 140 may also include a nonwoven fabric formed from a high-melting point glass fiber, a polyethylene terephthalate fiber, etc.

According to embodiments, an electrode cell may be defined by the cathode 100, the anode 130, and the separator 140, and a plurality of electrode cells may be laminated to form an electrode assembly 150 in the form of, for example, a jelly roll. For example, the electrode assembly 150 may be formed through winding, lamination, folding, etc. of the separator 140.

The electrode assembly 150 may be accommodated together with an electrolyte in an outer case 160 to define the lithium secondary battery.

According to embodiments, a non-aqueous electrolyte may be included in the outer case 160.

The non-aqueous electrolyte may include a lithium salt, as an electrolyte, and an organic solvent. The lithium salt may be expressed as, for example, Li⁺X⁻, and examples of anion (X⁻) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻ and (CF₃CF₂SO₂)₂N⁻.

Examples of the organic solvent may include propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, gamma-butyrolactone, propylene sulfite, and tetrahydrofuran. These may be used alone or in combination of two or more.

As illustrated in FIG. 1, an electrode tab (cathode tab and anode tab) may protrude from each of the cathode current collector 105 and the anode current collector 125 belonging to each electrode cell and may extend to a side of the outer case 160. The electrode tabs may be fused together with the side of the outer case 160 to form electrode leads (cathode leads 107 and anode leads 127) that extend or are exposed to the outside of the outer case 160.

For example, the lithium secondary battery may be manufactured in a cylindrical shape, a square shape, a pouch shape, or a coin shape using a can.

Hereinafter, embodiments of the present disclosure are additionally described with reference to specific experimental examples. Embodiments and comparative examples included in the experimental examples are only illustrative of the present disclosure and do not limit the scope of the appended claims. It will be apparent to those skilled in the art that various changes and modifications to embodiments are possible within the scope and technical idea of the present disclosure, and it is also natural that such changes and modifications fall within the scope of the appended claims.

### Embodiment 1

### (1) Manufacturing of Lithium-Transition Metal Composite Oxide Particles

NiSO₄, CoSO₄, and MnSO₄ were mixed in a ratio of 0.885:0.090:0.025 using distilled water, in which dissolved oxygen was removed, by bubbling with N₂ for 24 hours. The solution was put into a reactor at 50° C., and a coprecipitation reaction was performed for 48 hours using NaOH and NH₃H₂O as a precipitant and a chelating agent to obtain Ni_{0.885}Co_{0.09}Mn_{0.025}(OH)₂ as a transition metal precursor. The obtained precursor was dried at 80° C. for 12 hours and then re-dried at 110° C. for 12 hours.

Lithium hydroxide and the transition metal precursor were added to a dry high-speed mixer in a ratio of 1.01:1 and uniformly mixed for 5 minutes.

The mixture was put in a sintering furnace, heated to 730 to 750° C. at a rate of 2° C./min, and maintained at 730 to 750° C. for 10 hours. During the heating and the maintenance, oxygen was continuously passed at a flow rate of 20 L/min. After the sintering was completed, natural cooling was performed to room temperature, and lithium-transition metal composite oxide particles with a composition of LiNi_{0.885}Co_{0.09}Mn_{0.025}O₂ were obtained through pulverization and classification.

### (2) Manufacturing of Lithium Secondary Battery

A lithium secondary battery was manufactured using the obtained lithium-transition metal composite oxide particles as a cathode active material.

Specifically, the cathode active material, Denka Black as a conductive additive, and PVDF as a binder were mixed in a mass ratio of 97:2:1 to manufacture a cathode mixture. The manufactured cathode mixture was coated on an aluminum current collector, and then dried and pressed to manufacture a cathode.

An anode slurry including 93 wt % of natural graphite as an anode active material, 5 wt % of KS6 which is a flake type conductive additive as a conductive additive, 1 wt % of styrene-butadiene rubber (SBR) as a binder, and 1 wt % of carboxymethyl cellulose (CMC) as a thickener was manufactured. The anode slurry was coated on a copper substrate, dried, and pressed to manufacture an anode.

The cathode and the anode manufactured as described above were laminated by performing a predetermined notch, and a separator (polyethylene, thickness of 25 μm) was interposed between the cathode and the anode to form an electrode cell. Then, tab portions of the cathode and the anode were welded. An assembly of the welded cathode/separator/anode was put in a pouch, and three sides except an electrolyte injection side were sealed. In this instance, a portion with the electrode tabs was included in a sealing portion. The electrolyte was injected through a non-sealing portion, and the remaining sides were pressed and impregnated for 12 hours or more.

The electrolyte was prepared by dissolving LiPF₆ in a mixed solvent of EC/EMC/DEC (25/45/30; volume ratio) to have a concentration of 1 M, and then adding 1 wt % of vinylene carbonate (VC), 0.5 wt % of 1,3-propene sultone (PRS), and 0.5 wt % of lithium bis(oxalato) borate (LiBOB).

The secondary battery manufactured as described above was then pre-charged at a current (5 A) corresponding to 0.25 C for 36 minutes. Degassing was performed after 1 hour, and aging was performed for more than 24 hours. Afterwards, formation charge and discharge were performed (charge condition: CC-CV 0.2C 4.2V 0.05C CUT-OFF, discharge condition: CC 0.2C 2.5V CUT-OFF).

### Embodiment 2

A lithium-transition metal composite oxide and a lithium secondary battery were manufactured in the same method as the Embodiment 1, except that NiSO₄, CoSO₄, and MnSO₄ were mixed in a ratio of 0.9:0.05:0.05, respectively.

### Embodiment 3

### (1) Manufacturing of Lithium-Transition Metal Composite Oxide Particles

NiSO₄, CoSO₄, and MnSO₄ were mixed in a ratio of 0.885:0.090:0.025 using distilled water, in which dissolved oxygen was removed, by bubbling with N₂ for 24 hours. The solution was put into a reactor at 50° C., and a coprecipitation reaction was performed for 48 hours using NaOH and NH₃H₂O as a precipitant and a chelating agent to obtain Ni_{0.885}Co_{0.09}Mn_{0.025}(OH)₂ as a transition metal precursor. The obtained precursor was dried at 80° C. for 12 hours and then re-dried at 110° C. for 12 hours.

Lithium hydroxide and the transition metal precursor were added to a dry high-speed mixer at a ratio of 1.01:1, and titanium dioxide and zirconium hydroxide were added so that a molar ratio of Ni:Co:Mn:Ti:Zr was 0.885:0.090:0.025:0.015:0.01, and then uniformly mixed for 5 minutes.

The mixture was put in a sintering furnace, heated to 730 to 750° C. at a rate of 2° C./min, and maintained at 730 to 750° C. for 10 hours. During the heating and the maintenance, oxygen was continuously passed at a flow rate of 20 L/min. After the sintering was completed, natural cooling was performed to room temperature, and lithium-transition metal composite oxide particles with a composition of LiNi_{0.885}Co_{0.09}Mn_{0.025}Ti_{0.015}Zr_{0.01}O₂ were obtained through pulverization and classification.

### (2) Manufacturing of Lithium Secondary Battery

A lithium secondary battery was manufactured in the same method as the Embodiment 1, except that the lithium-transition metal composite oxide particles were used.

### Comparative Example 1

A lithium-transition metal composite oxide and a lithium secondary battery were manufactured in the same method as the Embodiment 1, except that NiSO₄, CoSO₄, and MnSO₄ were mixed in a ratio of 0.8:0.1:0.1, respectively.

### Comparative Example 2

A lithium-transition metal composite oxide and a lithium secondary battery were manufactured in the same method as the Embodiment 1, except that NiSO₄, CoSO₄, and MnSO₄ were mixed in a ratio of 0.7:0.2:0.1, respectively.

### Experimental Example 1: Measurement of (105) Plane FWHM Ratio

Each of the lithium secondary batteries according to embodiments and comparative examples was manufactured as a coin cell for in-situ measurement. The coin cell was charged (CC-CV 0.1C 4.2V 0.05C CUT-OFF) and discharged (CC 0.01C 2.5V CUT-OFF) once each to perform a formation process, and then the in-situ XRD was measured using the X′Pert PRO and Empyren equipment made by PANalytical.

The coin cell was put into the in-situ XRD and performed the charge (CC-CV 0.1C 4.2V 0.05C CUT-OFF) and discharge (CC 0.1C 2.5V CUT-OFF) once, and a FWHM value of a (105) plane peak of lithium-transition metal composite oxide particles was measured once every 7 minutes during one charge process and one discharge process.

A maximum FWHM value measured was defined as FWHMₘₐₓ(105), a minimum FWHM value measured was defined as FWHMₘᵢₙ(105), and the FWHM ratio was calculated according to Equation 1. The calculated values are shown in Table 1 below.

### Experimental Example 2: Measurement of Gas Generation Amount

1) The lithium secondary batteries according to embodiments and comparative examples were left in a 60° C. chamber for 4 weeks. Thereafter, they were left at room temperature for 30 minutes and put in a chamber for measuring an amount of gas generated. After a vacuum was formed in the chamber, nitrogen gas was filled in the chamber to form an atmospheric pressure. In this instance, a nitrogen volume V₀ and a pressure in the chamber P₀ were measured. After a vacuum was formed again in the chamber, a hole was made in the battery and a pressure in the chamber P₁ was measured, and an amount of gas generated was calculated based on Equation 2 below.

$$Gas generation amount ( mL ) = ( {V}_{0} / {P}_{0} ) * {P}_{1} \qquad [ Equation 2 ]$$

2) After the lithium secondary batteries according to embodiments and comparative examples were left in the 60° C. chamber for 8 weeks, the gas generation amount was calculated in the same manner as described above.

The calculated values were shown in Table 1 below.

### Experimental Example 3: Measurement of Capacity Retention Rate after High Temperature Storage

1) The lithium secondary batteries according to embodiments and comparative examples were charged (CC-CV 0.2C 4.2V 0.05C CUT-OFF) and discharged (CC 0.2C 2.5V CUT-OFF), and an initial discharge capacity was measured.

Then, the lithium secondary batteries according to embodiments and comparative examples were left in a 60° C. chamber for 4 weeks, and then left at room temperature for 30 minutes. The lithium secondary batteries were charged (CC-CV 0.2C 4.2V 0.05C CUT-OFF) and discharged (CC 0.2C 2.5V CUT-OFF), and a discharge capacity after 4 weeks of high temperature storage was measured.

2) The lithium secondary batteries according to embodiments and comparative examples were left in the 60° C. chamber for 8 weeks, and the discharge capacity after 8 weeks of high temperature storage was measured in the same manner as described above.

The discharge capacity after 4 or 8 weeks of high temperature storage with respect to the initial discharge capacity was calculated as a % value and was shown in Table 1 below.

### Experimental Example 4: Measurement of Resistance Increase Rate after High Temperature Storage

1) The lithium secondary batteries according to embodiments and comparative examples were charged at 0.5C CC/CV (4.2V 0.05C CUT-OFF) at 25° C., and then discharged at 0.5C CC until SOC 60. At the SOC 60 point, the C-rate was changed to 0.2C, 0.5C, 1.0C, 1.5C, 2.0C, and 2.5C, and the lithium secondary batteries were discharged and recharged for 10 seconds to measure DCIR R1. The charged lithium secondary batteries according to embodiments and comparative examples were left in a 60° C. chamber for 4 weeks, and then left at room temperature for 30 minutes, and DCIR R2 was measured in the same manner as described above. An internal resistance increase rate was calculated based on Equation 3 below, and the results were shown in Table 1 below.

$$Internal resistance increase rate ( \% ) = ( R 2 - R 1 ) / R 1 \times 100 ( \% ) \qquad [ Equation 3 ]$$

2) The lithium secondary batteries according to embodiments and comparative examples were left in the 60° C. chamber for 8 weeks, and then internal resistance increase rate was calculated in the same manner as described above.

The calculated values were shown in Table 1 below.

TABLE 1

| | | | | | | Capacity | | Resistance | |
|---|---|---|---|---|---|---|---|---|---|
| | | | | | | retention | | increase | |
| | | | | Gas | | rate after | | rate after | |
| | | | | generation | | high | | high | |
| | (105) plane | | | amount | | temperature | | temperature | |
| | FWHM | | | (mL) | | storage (%) | | storage (%) | |
| | Max | Min | Ratio | 4 | 8 | 4 | 8 | 4 | 8 |
| | value | Value | (%) | weeks | weeks | weeks | weeks | weeks | weeks |
| Embodiment | 0.8325 | 0.1550 | 537 | 11 | 15 | 97 | 91 | 103 | 109 |
| 1 | | | | | | | | | |
| Embodiment | 0.9525 | 0.1860 | 512 | 10 | 16 | 98 | 90 | 102 | 109 |
| 2 | | | | | | | | | |
| Embodiment | 0.9125 | 0.1653 | 552 | 1 | 14 | 97 | 91 | 101 | 108 |
| 3 | | | | | | | | | |
| Comparative | 1.0985 | 0.1625 | 676 | 17 | 28 | 94 | 88 | 107 | 113 |
| Example 1 | | | | | | | | | |
| Comparative | 1.0225 | 0.1611 | 635 | 15 | 22 | 95 | 87 | 105 | 111 |
| Example 2 | | | | | | | | | |

Referring to Table 1 above, in the embodiments 1 to 3, the (105) plane FWHM ratio was less than or equal to 600%, and even if the lithium secondary batteries are stored at high temperature for a long period of time, the amount of gas generated inside the batteries was small, and the performance degradation after high temperature storage was reduced.

In particular, in the embodiment 3 using a cathode active material including a doped metal, the gas generation amount was very small, and the resistance increase rate after high temperature storage was further reduced.

On the other hand, in the comparative examples 1 and 2, the (105) plane FWHM ratio exceeded 600%, and it could be seen that the gas generation amount inside the batteries was relatively increased compared to the embodiments, and the high temperature storage characteristics were deteriorated.

What is claimed is:

1. A cathode active material for lithium secondary battery including lithium-transition metal composite oxide particles in which a (105) plane FWHM ratio measured through in-situ X-ray diffraction (XRD) and defined by Equation 1 below is less than or equal to 600%:
$$( 105 ) plane FWHM ratio ( \% ) = 100 * ( {FWHM}_{max} ( 105 ) / {FWHM}_{min} ( 105 ) ) \qquad [ Equation 1 ]$$
where FWHMₘₐₓ(105) is a maximum FWHM value of a (105) plane peak of the lithium-transition metal composite oxide particles measured through the in-situ XRD, and
FWHMₘᵢₙ(105) is a minimum FWHM value of the (105) plane peak of the lithium-transition metal composite oxide particles measured through the in-situ XRD.

2. The cathode active material for lithium secondary battery of claim 1, wherein the (105) plane FWHM ratio is 450 to 550%.

3. The cathode active material for lithium secondary battery of claim 1, wherein the (105) plane FWHM ratio is 512 to 552%.

4. The cathode active material for lithium secondary battery of claim 1, wherein the FWHMₘₐₓ(105) is 0.5 to 1.0.

5. The cathode active material for lithium secondary battery of claim 1, wherein the FWHMₘᵢₙ(105) is 0.1 to 0.16.

6. The cathode active material for lithium secondary battery of claim 1, wherein a change in a FWHM value of the (105) plane peak of the lithium-transition metal composite oxide particles based on a charge and a discharge of the lithium secondary battery is measured in real time through the in-situ XRD.

7. The cathode active material for lithium secondary battery of claim 1, wherein the lithium-transition metal composite oxide particles include at least one doping element.

8. The cathode active material for lithium secondary battery of claim 1, wherein the lithium-transition metal composite oxide particles have a secondary particle structure including a plurality of primary particles.

9. The cathode active material for lithium secondary battery of claim 8, wherein the secondary particle structure includes 2 to 5 primary particles.

10. The cathode active material for lithium secondary battery of claim 1, wherein the lithium-transition metal composite oxide particles have a single crystal structure.

11. The cathode active material for lithium secondary battery of claim 1, wherein the lithium-transition metal composite oxide particles are represented by formula 1 below: 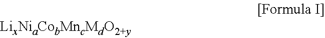
where M includes at least one of Ti, Zr, Al, Mg or W, and
0.8<x<1.5, 0.70≤a≤0.98, 0≤b≤0.20, 0.02≤c≤0.30, 0≤d≤0.05, 0.985a+b+c≤1.02, and −0.1≤y≤0.1.

12. The cathode active material for lithium secondary battery of claim 11, wherein in the Formula 1, 0.85≤a≤0.98.

13. A lithium secondary battery comprising:
a cathode including a cathode active material layer including a cathode active material for lithium secondary battery according to claim 1; and
an anode opposite the cathode.
